(19) United States
(12) Patent Application Publication
(10) Pub. No.: US 2019/0037611 A1
(43) Pub. Date: Jan. 31, 2019

(54) INTUITIVE INTER-DEVICE CONNECTIVITY FOR DATA SHARING AND COLLABORATIVE RESOURCE USAGE

(71) Applicant: Google LLC, Mountain view, CA (US)

(72) Inventors: Marius RENN, San Jose, CA (US); Wei HUA, Palo Alto, CA (US)

(21) Appl. No.: 14/139,376

(22) Filed: Dec. 23, 2013

(51) Int. Cl. H04W 76/02; G06F 3/0486

(52) U.S. Cl. CPC H04W 76/02; G06F 3/0486

(57) ABSTRACT

Embodiments of the invention provide client devices, servers, systems, and methods for establishing, managing, and utilizing inter-device connectivity environments that enable inter-device data and resource sharing through intuitive user commands. The invention does not require client devices having specialized hardware necessary for forming direct client connections, such as NFC readers or RFID antennas. Embodiments of the invention utilize an environment wherein multiple client devices communicate with a server to enable the transfer of files from one client device to another. The server manages the transfer of data between clients and the sharing of client resources between clients. Specifically, the server determines whether inter-device sharing events detected and reported by client devices are valid inter-device sharing events. If such events are valid, the server further facilitates the data and resource sharing process.

### BACKGROUND

As mobile computerized devices become increasingly popular, such devices are more frequently used in social settings involving multiple users co-located in the same room or other area. In such settings, users may desire to share content located on a first mobile computerized device with content located on a second mobile computerized device. However, many methods of inter-device connectivity require user participation in what are often cumbersome configuration procedures. For example, in order to establish a connection with other devices, users may be required to manually input information including but not limited to a device ID corresponding to the other devices, a network encryption key, and a password. Requiring such information provides a measure of security in the information transfer process but also represents a hindrance to straightforward and intuitive sharing of content.

Additional methods of inter-device connectivity utilize near field communication (NFC) technologies to facilitate the sharing of information between multiple devices. NFC and other short range wireless communication technologies are only effective over very short distances and thereby require that devices be located in extremely close proximity in order for a connection to be established. Such a proximity requirement provides a measure of security analogous to that provided by a shared network password in other prior art methods. However, NFC and other short range wireless communication technologies require participating devices to have specialized hardware capable of establishing short-range wireless communication connections. A mobile computerized device that does not have the required hardware will not be able to participate in such inter-device connections. However, the inclusion of hardware that enables NFC and other short-range wireless communication connections increases mobile device cost and complexity.

### SUMMARY

Embodiments of the invention provide client devices, servers, systems, and methods for establishing, managing, and utilizing inter-device connectivity environments that enable inter-device data and resource sharing through intuitive user commands. The invention does not require client devices having specialized hardware necessary for forming direct client connections, such as NFC readers or RFID antennas. Embodiments of the invention utilize an environment wherein multiple client devices communicate with a server to enable the transfer of files from one client device to another. The server manages the transfer of data between clients and the sharing of client resources between clients. Specifically, the server determines whether inter-device sharing events detected and reported by client devices are valid inter-device sharing events. If such events are valid, the server further facilitates the data and resource sharing process.

One embodiment of the invention contemplates a system comprising a first client device, a second client device, and a server, wherein the first client device is configured to detect an exit gesture, and transmit exit gesture data generated by the exit gesture, wherein the second client device is configured to detect an entrance gesture, and transmit entrance data generated by the entrance gesture, wherein the server is configured to receive the exit gesture data, receive the entrance gesture data, determine a gesture type of an interdevice gesture formed from the exit gesture data and the entrance gesture data, and transmit a pairing message.

An alternative embodiment of the invention contemplates a client device comprising one or more processors and computer readable storage media, the client device further comprising a touch sensitive screen configured to detect a drag gesture and to produce a signal corresponding to the drag gesture, and an inter-device connection engine configured to send data representing the physical size of the touch sensitive screen, data representing the geographic location of the client device, and data uniquely identifying the client device, to determine if a drag gesture is an exit event, and to transmit data representative of the drag gesture if the drag gesture is an exit event.

An additional embodiment of the invention contemplates a method for recognizing an interdevice gesture originated at a first client device comprising computer readable storage media and consummated at a second client device comprising computer readable storage media, the method comprising receiving first data corresponding to a first drag event detected at a first client device from the first client device, receiving data composing a file from the first client device, receiving second data corresponding to a second drag event detected at a second client device from the second client device, determining whether the first data matches the second data, and transmitting the file received from the first client device to the second client device when the first data matches the second data wherein the first data comprises a time at which the first drag event ended and a location of the first client device, wherein the second data comprises a time at which the second drag event begun and a location of the second client device, and wherein determining whether the first data matches the second data comprises determining whether the time at which the first drag event ended is within a threshold of the time at which the second drag event begun and determining whether the geographic location of the first device is within a threshold distance of the geographic location of the second device.

### BRIEF DESCRIPTION OF THE DRAWINGS

FIG. 1 is a block diagram of an example environment in which the methodology for intuitive inter-device connectivity for data sharing and collaborative resource usage may be implemented;

FIG. 2 is a block diagram of the basic functional components for an example client device depicted in FIG. 1, according to one aspect of the disclosure;

FIG. 3 is a block diagram of the basic functional components for an inter-device connection management server depicted in FIG. 1, according to one aspect of the disclosure;

FIG. 4 is a flow diagram illustrating an example process, implemented at a client device, for intuitively forming an inter-device connection for data sharing and collaborative resource usage;

FIG. 5 depicts an inter-device connectivity user interface at two distinct client devices aligned adjacent to one another;

FIG. 6 depicts three client devices arranged next to one another in order to form a mosaic during an expanded viewing event;

FIG. 7 is a flow diagram illustrating an example process, implemented at an inter-device connection management server, for establishing and managing an inter-device connectivity cluster.

### DETAILED DESCRIPTION

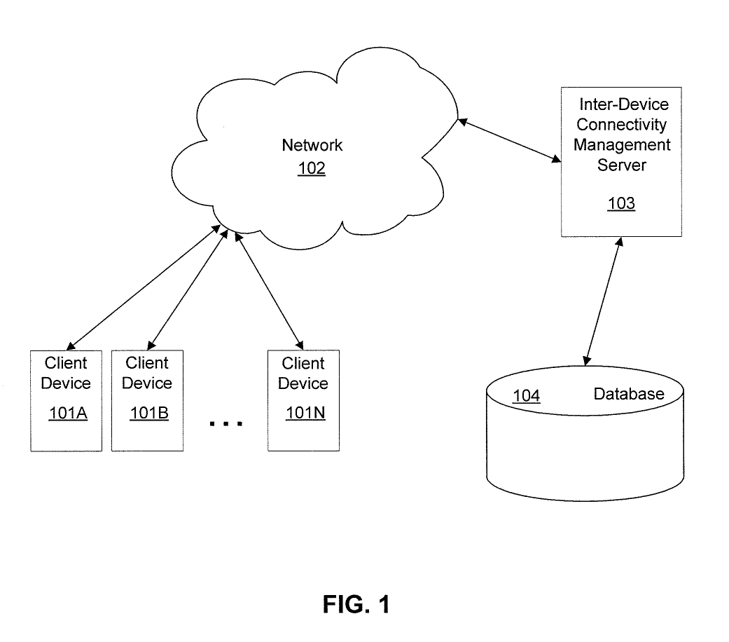

FIG. 1 is a block diagram of an example environment in which the methodology for intuitive inter-device connectivity for data sharing and collaborative resource usage may be implemented. In the example environment depicted in FIG. 1, client devices 101A and 101B through 101N are connected to a network 102. The network 102 enables the client devices 101 to communicate with an inter-device connection management server 103. The inter-device connection management server 103 is further connected to a database 104. Database 104 stores a variety of information, including information pertaining to user accounts affiliated with the various client devices 101.

Client devices 101 may be any of a smart phone, a personal digital assistant (PDA), a tablet computer, a wearable computer, a laptop computer, a video-game console, or any one of a number of additional devices that may establish communicative connections with an inter-device connection management server over a network. Although it not required by all implementations, clients having a touch-screen input device are required for particular implementations of the invention. Client devices 101 are capable of sending information to and receiving information from the inter-device connection management server 103. The client devices 101 may receive data and information that is pushed from the inter-device connection management server 103 and may also receive transmissions of data and information that are responsive to requests previously sent by the client devices 101 to the inter-device connection management server 103. For example, client devices 101 may request that the inter-device connection management server 103 create a connectivity cluster that includes one or more client devices 101 and that enables certain inter-device connectivity functionality to be implemented.

The network 102 connects the client devices 101 to the inter-device connection management server 103. The network 102 may be either a wired or a wireless network, and may include elements of a cellular network, a voice over internet protocol (VoIP) network, a public switched telephone network (PSTN), or combinations thereof. Example networks include but are not limited to an LTE network, a GSM network, a CDMA network, a fiber optic network, and other voice or data networks. The network 102 may also include elements of WLAN or WPAN networks that enable the client devices 101 to connect to other components of the network, for example an LTE network. The network 102 may include a set of cell towers, as well as a set of base stations and/or mobile switching centers (MSCs). As appreciated by those skilled in the art, the network 102 may include various cell tower/base station/MSC arrangements. For example, a base station and a cell tower could be co-located at the same site or remotely located at different sites. A single base station could be coupled to various cell towers or various base stations could be coupled to a single MSC, to name but a few of the possible arrangements. Alternatively or in addition to the aforementioned components of the network 102, the network 102 may include one or more IP multimedia subsystems (IMS), serving gateways (SGW), and evolved node Bs (eNB). One of ordinary skill in the art will recognize that additional components not mentioned herein may be used by the network 102.

The inter-device connection management server 103 comprises processors and memory configured to receive requests for information from the client devices 101 and to provide data and information to the client devices 101. The inter-device connection management server 103 is in particular configured to receive information from the client devices 101 that is indicative of the proximity of individual client devices to one another, to receive requests from the client devices 101 to form inter-device connectivity clusters, to receive information from the client devices 101 that is representative of an attempt by client devices within a connectivity cluster to share data or to collaboratively utilize resources, as well as additional information. The inter-device connection management server 103 is further configured to manage the transfer of data and the collaborative use of resources between within inter-device connectivity clusters.

Processors and memory located at the inter-device connection management server 103 may also be configured to both access information stored at a database and to store information at a database, such as database 104. The inter-device connection management server 103 may be configured to access information pertaining to user account preferences for inter-device connectivity clusters stored at the database 104. Such user account preferences may include connectivity cluster and share group preferences that are not limited to enablement or disablement of certain features typically provided within an inter-device connectivity cluster or share group environment, a set of defined user interface (UI) gestures and corresponding actions to be taken by a client or server in response to the receipt of such UI gestures. Furthermore, connectivity cluster and share group preferences may include a list of sharing permission where permissions are assigned based on user accounts and user account connections, e.g. a friends list or list of business contacts. The database 104 may also store a variety of information, including, e.g., user account names, the names of users to whom the user accounts belong, aliases for the user accounts, verification information for the user accounts, social network profiles associated with the user accounts, images associated with the user accounts, documents and media content associated with the user accounts, and various user account settings.

Embodiments of the invention that may be practiced in the example environment represented by FIG. 1 are generally drawn towards methodologies for intuitive inter-device connectivity for data sharing and collaborative resource usage. Embodiments of the invention provide client devices, servers, systems, and methods for establishing, managing, and utilizing inter-device connectivity environments that can be established through intuitive user commands and that enable data sharing and collaborative resource usage across devices. The invention does not require client devices to have short range wireless communication capabilities, e.g. NFC readers or RFID antennas. Embodiments of the invention utilize information provided to a server by one or more client devices to identify and execute inter-device data and resource sharing events. The invention contemplates the creation of connectivity clusters, i.e. groups of devices that are potential candidates for data and resource sharing with other devices that are members of the group. Such connectivity clusters may be identified and defined by a common geographic location, a common interaction with a network. Share groups within a connectivity cluster may further be defined based on connections between user accounts affiliated with devices of a connectivity cluster, additional contextual information, and combinations thereof. For example, all devices with a threshold-exceeding received signal strength indication (RSSI) from a particular WIFI access point may be candidates for an inter-device connectivity cluster.

Embodiments of the invention further contemplate monitoring input received by candidates for an inter-device connectivity cluster and analyzing received input to determine whether one or more candidates intend to share data or resources with one or more other candidates. In some implementations, candidate devices must affirmatively request that a server form an inter-device connectivity cluster or must approve a request from a server for the formation of a cluster. Such implementations may be referred to as requiring explicit connectivity clustering. In other implementations a server may automatically create an inter-device connectivity cluster upon determining that more than one device meets particular criteria. For example, a server may automatically form a connectivity cluster upon determining that multiple client devices exhibit a threshold-exceeding RSSI from a particular WIFI access point. Such implementations may be referred to as allowing implicit connectivity clustering. Formation of share groups within the connectivity clusters is also contemplated by the invention. A server may enable client devices that have become members of a share group to perform actions that are not allowed between other members of the inter-device connectivity cluster.

Inter-device connectivity management servers contemplated by the invention are configured to receive a request from one or more clients that are members of an implicitly formed connectivity cluster, an explicitly formed connectivity cluster, or a share group within a connectivity cluster and to process the requests in order to execute particular inter-device sharing actions. In some implementations, inter-device connectivity management servers are configured to verify that a request to perform an inter-device sharing action matches an inter-device sharing action requested by a second device. In the event that the request to perform the action is not verified, the connectivity management server may be configured to transmit a request failed message to the requesting client(s). In the event that the request to perform the action is verified, the connectivity management server may be configured to execute the action requested by the client(s) and to perform additional auxiliary actions attendant to the requested action.

Client devices contemplated by the invention are configured to receive input from a user that indicates a user's desire that particular actions enabled by an inter-device connectivity cluster be performed. Client devices contemplated by the invention may function to both initiate or request particular actions attendant to inter-device connectivity and to verify or affirm actions initiated or requested by another device in within the same cluster or share group. For example, client devices contemplated by the invention may both initiate a request to transmit data and accept a request to transmit data that was initiated at a distinct device. Certain implementations may involve devices that are only able to initiate or request particular actions within a connectivity cluster or share group. Implementations may also involve devices that are only able to accept or verify actions initiated by other devices within a cluster or share group.

Implementations of the invention contemplate both the sharing of data between multiple devices within a connectivity cluster or share group and the sharing of resources between devices within the connectivity cluster or share group. The invention contemplates the seamless sharing of various multimedia files and other files between devices within a share group or connectivity cluster through commands that are intuitive to a user, such as a drag and drop UI gesture or a voice command. The invention also contemplates the sharing of client resources, such as output devices and processing power, through intuitive user commands. For example, a user may double tap a recently stored photo to view the photo across multiple client devices where each device displays a portion of the photo.

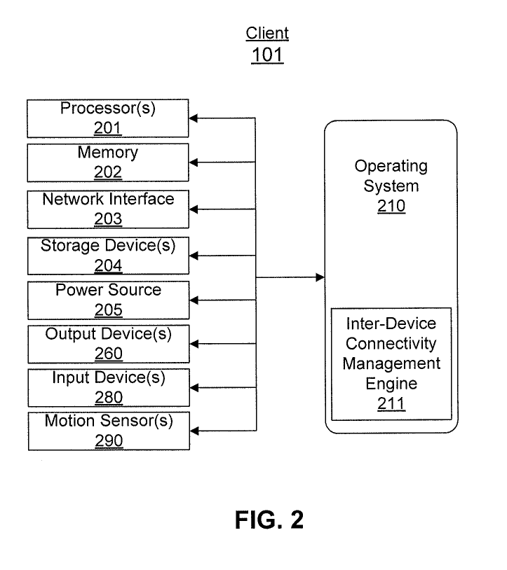

Turning now to FIG. 2, a block diagram of the basic functional components for an example client device of FIG. 1 is depicted. In general, many other embodiments of the client device 101 may be used as long as the embodiment is capable of receiving and transmitting data over one or more wireless interfaces. In the embodiment illustrated by FIG. 2, the client device 101 includes one or more processors 201, memory 202, a network interface 203, one or more storage devices 204, a power source 205, one or more output devices 260, one or more input devices 280, and one or more motion sensors 290. The client device 101 also includes an operating system 210 that is executable by the client 101, and further includes an inter-device connectivity management engine 211. In some implementations, the inter-device connectivity management engine 211 may be a component of the operating system 210 (as is depicted by FIG. 2). In alternative implementations, the inter-device connectivity management engine may be separate and distinct from the operating system 210 or may comprise elements of the operating system 210 as well as elements that are external to the operating system 210. In a conventional fashion, each of components 201, 202, 203, 204, 205, 210, 211, 260, 280, and 290 are interconnected physically, communicatively, and/or operatively for inter-component communications.

As illustrated, processors 201 are configured to implement functionality and/or process instructions for execution within the client device 101. For example, processors 201 execute instructions stored in memory 202 or instructions stored on storage devices 204. Memory 202, which may be a non-transient, computer-readable storage medium, is configured to store information within the client device 101 during operation. In some embodiments, memory 202 includes a temporary memory, i.e. an area for information to be maintained when the client device 101 is turned off. Examples of such temporary memory include volatile memories such as random access memories (RAM), dynamic random access memories (DRAM), and static random access memories (SRAM). Memory 202 also maintains program instructions for execution by the processors 201.

The client device 101 uses network interface 203 to communicate with external devices via one or more networks, such as the network 104 of FIG. 1. The network interface 203 may include multiple interfaces for connecting with various types of networks. Such networks may include one or more wireless networks, wired networks, fiber optics networks, and other types of networks through which communication between the client 101 and an external device may be established. Network interface 203 may include a network interface card, such as an Ethernet card, an optical transceiver, a radio frequency transceiver, or any other type of device that can send and receive information. Other non-limiting examples of interfaces that may be included in the network interface 203 include Bluetooth, 3G and WiFi radios as well as USB interfaces.

Storage devices 204 also include one or more non-transient computer-readable storage media. Storage devices 204 are generally configured to store larger amounts of information than memory 202. Storage devices 204 may further be configured for long-term storage of information. In some examples, storage devices 204 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The client 101 includes one or more power sources 205 to provide power to the client. Non-limiting examples of power source 205 include single-use power sources, rechargeable power sources, and/or power sources developed from nickel-cadmium, lithium-ion, or other suitable material.

The client 101 includes one or more input devices 280. Input devices 280 are configured to receive input from a user through tactile, audio, and/or video feedback. Non-limiting examples of input device 280 include a presence-sensitive screen, a keyboard, a voice responsive system, a video camera, a microphone, and any other type of device for detecting a command from a user. In some examples, a presence-sensitive screen includes a touch-sensitive screen.

One or more output devices 260 are also included in client 101. Output devices 260 are configured to provide output to a user using tactile, audio, and/or video stimuli. Output device 260 may include a display screen (which may be part of a presence-sensitive screen), a sound card, a video graphics adapter card, or any other type of device for converting a signal into an appropriate form understandable to humans or machines. Additional examples of output device 260 include a speaker, a liquid crystal display (LCD), or any other type of device that can generate intelligible output to a user. The motion sensors 290 are configured to detect motion of the client 101. The motion sensors 290 may include but are not limited to accelerometers and gyroscopes.

The client 101 includes an operating system 210, such as the Android® operating system. The operating system 210 controls operations of the components of the client 101. For example, the operating system 210 facilitates the interaction of the processors 201, memory 202, network interface 203, storage device(s) 204, input device 280, output device 260, power source 205, and motion sensors 290.

The client 101 further includes an inter-device connectivity management engine 211. In various implementations the inter-device connectivity management engine 211 may be a component of the operating system 210, may comprise components of the operating system 210, or may be distinct from the operating system 210. The inter-device connectivity management engine 211 is configured with processor executable instructions. Such processor executable instructions may facilitate the interaction of the processors 201, memory 202, network interface 203, storage device(s) 204, output device 260, input device 280, and motion sensors 290. The inter-device connectivity management engine 211 is configured to transmit and receive data from the inter-device connectivity management server 103. The inter-device connectivity management engine 211 is further configured to receive user input that corresponds to an action enabled by a connectivity cluster or a share group.

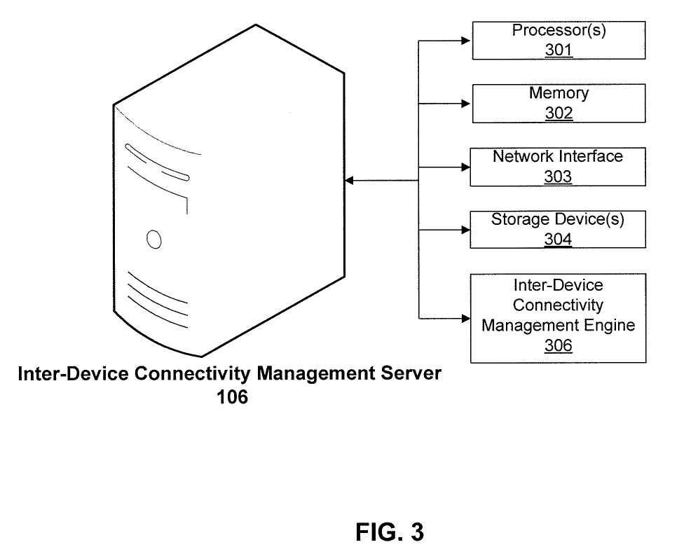

FIG. 3 is a block diagram of the basic functional components for the inter-device connectivity management server 103 depicted in FIG. 1, according to one aspect of the disclosure. The inter-device connectivity management server 300 includes one or more processors 301, memory 302, a network interface 303, one or more storage devices 304, and a inter-device connectivity management engine 305. In a conventional fashion, each of components 301, 302, 303, 304, and 305 are interconnected physically, communicatively, and/or operatively for inter-component communications. In various implementations, the various elements of the inter-device connectivity management server may be distributed across multiple physical devices communicatively connected but remotely located at different physical locations.

As illustrated, processors 301 are configured to implement functionality and/or process instructions for execution within inter-device connectivity management server 300. For example, processors 301 execute instructions stored in memory 302 or instructions stored on storage devices 304. Memory 302, which may be a non-transient, computer-readable storage medium, is configured to store information within inter-device connectivity management server 300 during operation. In some embodiments, memory 302 includes a temporary memory, i.e. an area for information to be maintained when the inter-device connectivity management server 300 is turned off. Examples of such temporary memory include volatile memories such as random access memories (RAM), dynamic random access memories (DRAM), and static random access memories (SRAM). Memory 302 also maintains program instructions for execution by the processors 301.

Storage devices 304 also include one or more non-transient computer-readable storage media. Storage devices 304 are generally configured to store larger amounts of information than memory 302. Storage devices 304 may further be configured for long-term storage of information. In some examples, storage devices 304 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The inter-device connectivity management server 300 uses network interface 303 to communicate with external devices via one or more networks, such as the network 103 of FIG. 1. Such networks may include one or more wireless networks, wired networks, fiber optics networks, and other types of networks through which communication between the inter-device connectivity management server 300 and an external device may be established. Network interface 303 may be a network interface card, such as an Ethernet card, an optical transceiver, a radio frequency transceiver, or any other type of device that can send and receive information.

Inter-device connectivity management engine 305 is configured to receive data and requests from one or more client devices, to establish inter-device connectivity clusters and identify client devices that are candidates for membership of the inter-device connectivity clusters, and to manage the sharing of data and resources between client devices that are members of an inter-device connectivity cluster. Inter-device connectivity management engine 305 may further be configured to create share groups within connectivity clusters and to manage the interaction between devices that are members of the same share group. Furthermore, the inter-device connectivity engine 305 may request and receive information pertaining to devices that are members of a connectivity cluster from the storage devices 304, from the database 104, and from other data stores located at the server 103 or located remotely from the server 103.

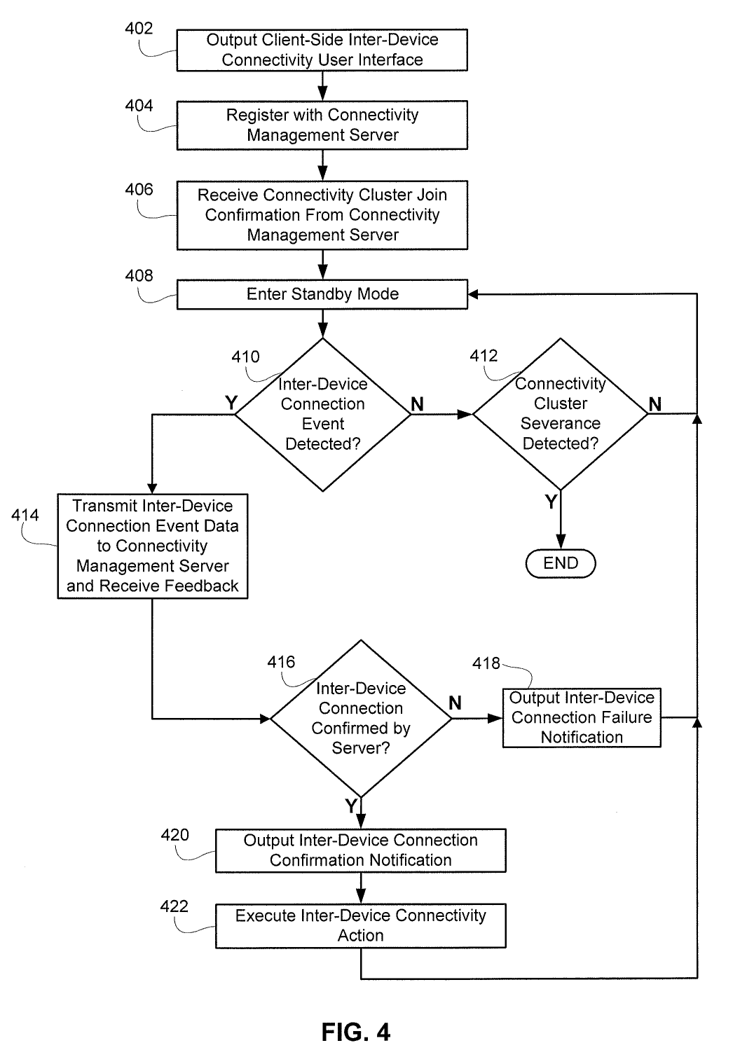

FIG. 4 is a flow diagram illustrating an example process, implemented at a client device, for intuitively forming an inter-device connection for data sharing and collaborative resource usage. At 402, the client device 101 outputs, via one or more of the output devices 260, a client-side inter-device connectivity user interface (UI). The inter-device connectivity UI may be a graphical UI, an auditory UI, any other type of UI, and may include combinations of multiple types of UI, e.g. a graphical and auditory UI. The inter-device connectivity UI output by the client device 101 at 402 may enable the client device 101 to establish a connectivity cluster, to join an existing connectivity cluster, or to otherwise utilize the inter-device connectivity management server 103 in order to share data and/or resources with other proximally located client devices. Outputting the inter-device connectivity UI at 402 may be responsive to user input or may be performed automatically by the client device upon the detection of particular circumstances. For example, connecting to a particular WIFI access point may trigger the output of the inter-device connectivity UI at 402.

At 404, the client device 101 registers with the inter-device connectivity management server 103. During the registration at 404, the client device 101 transfers a variety of information to the connectivity server 103. Such information may include but is not necessarily limited to a unique device identifier (device ID), device display information (e.g. physical screen size, pixel layout, etc.), and device location data (e.g. GPS coordinates, RSSI for one or more WIFI access points, etc.). In some implementations, the client device 101 may be configured to register with the connectivity server 103 prior to the loading of the inter-device connectivity UI. In such implementations, registration at 404 is executed before the UI is output at 402. In some implementations, outputting the inter-device connectivity UI at 402 automatically triggers the registration of the client device with the server at 404. Thus, a user may facilitate registration of the client device 101 with the inter-device connectivity management server 103 by choosing to view the inter-device user connectivity UI. In an alternative implementation, the registration performed at 404 may be executed by a wireless router or another local network device configured to perform such registration. For example, a WIFI router can register a connected device with the inter-device connectivity management server 103 upon establishing a connection with the device. In such an implementation, the device connected to the WIFI router would not independently re-register upon outputting the inter-device connectivity UI.

At 406, if the inter-device connectivity management server 103 is able to successfully add the client device 101 to a connectivity cluster, the client device 101 receives a connectivity cluster join confirmation from the connectivity management server 103. The connectivity cluster join confirmation message may include a variety of information not limited to a unique identifier for the connectivity cluster, a list of rules and settings that govern the sharing of resources and data within the connectivity cluster, a list of other client devices currently participating in the connectivity cluster, and information pertaining to the other participating client devices (such as an affiliated user account identity). In some implementations, the client device 101 may produce user-intelligible output at one of the output devices 260 in response to the receipt of the join confirmation at 406. The type and duration of such user-intelligible output can be configured by a user according to the user's preferences. By contrast, if the inter-device connectivity management server 103 is unable to add the client device 101 to an existing connectivity cluster or create a new connectivity cluster for the client device 101, the connectivity management server may transmit a notification indicating that the client device 101 was unable to be assigned to a connectivity cluster.

At 408, the client device 101 enters a standby mode in which the client device 101 awaits the receipt of data pertaining to inter-device connections. Cycles of the standby mode entered at 408 may correspond to processing cycles of one or more of the one or more processors 201 of the client device 101. At 410, the process determines whether an inter-device connection event has been detected by the client device 101. If a connection event is not detected during the standby cycle, the process determines whether the link to the connectivity cluster has been severed at 412. If the link to the connectivity cluster has been severed, e.g. due to the client device 101 moving outside the geographic location defining the connectivity cluster, due to the disbanding of the connectivity cluster by a participating client device or by the connectivity management server 103, or otherwise, the process ends. In some implementations, the end of the process may be followed by a re-registration with the inter-device connectivity management server 103. However, if an inter-device connection event is detected at 410, the process proceeds to 414.

At 414, the client device 101 transmits data corresponding to the inter-device connection event to the inter-device connectivity management server 103 and receives feedback from the connectivity management server. The client device 101 may be configured to recognize a variety of inter-device connection events. Inter-device connection events may include but are not limited to a touch screen input that is started on a first device and completed on a second device, a touch screen input on a single device, and a voice command. The data transmitted to the connectivity management server 103 at 414 may include but is not limited to a time stamp (i.e. the time at which the event occurred), a device ID corresponding to the device at which the event occurred, and additional data pertaining to the particular connection event that was detected. The client device 101 also receives feedback from the connectivity management server at 414. The feedback received at 414 indicates whether or not the inter-device connection event reported at 414 was confirmed by the server. Various types of confirmation may be required for different types of inter-device connection events, but many connection events reported by a first client device require that a second client device report a matching event in order to be confirmed.

At 416, the process determines whether or not the inter-device connection was confirmed by the server. If the inter-device connection was not confirmed by the server, the process proceeds to 418 where an inter-device connection failure notification output is generated by the client device. In many implementations, no output may be generated in the event that the inter-device connection is not confirmed. During the course of normal operation of a client device, a user may unintentionally register an inter-device connection event. In order to minimize the impact of such false reports, the client device may not produce any user-intelligible output upon determining that a reported inter-device connection event was not confirmed by the inter-device connectivity management server 103. Thereafter, the process returns to 408 where the client device resumes a standby mode and awaits the detection of a further inter-device connection event or the severance of a connection to the connectivity cluster.

By contrast, the if the inter-device connection event is confirmed by the server at 416, the process proceeds to 420 where an inter-device connection confirmation notification is output. If output is produced by the client device upon a successful inter-device connection, in the event that not output is produced by the client device a user may infer that no connection has been established. The confirmation output produced at 420 may consist of any visual, aural, and tactile output capable of being produced by one or more of the output devices 260 of the client device 101. After outputting an inter-device connection confirmation notification, the process proceeds to 422 where the inter-device connectivity action is executed. Thereafter, the process returns to 408 where the client device resumes a standby mode and awaits the detection of a further inter-device connection event or the severance of a connection to the connectivity cluster.

Client devices may be configured to detect inter-device connection events by recognizing the beginning of a touch screen input that ends on another client device or by recognizing the completion of a touch screen input that began on a different client device. Such touch screen inputs may be components of a multi-device drag-and-drop command whereby a user drags an item from a first device to a second device and possibly on to additional devices. In addition to a drag-and-drop command, a drag-to-connect gesture could be executed whereby no files are transferred from one device to another but a gesture beginning on a source device and ending on a target device is utilized to enable various inter-device resource or data sharing through the inter-device connectivity management server 103 or otherwise. A user could execute a drag event (whether part of a drag-and-drop gesture, a drag-to-connect gesture, or otherwise) through the use of a finger, stylus, or other object on a touch-sensitive screen or through the use of a pointing device on a screen capable of detecting the output of such a pointing device. The first device (at which the item was selected and the drag gesture was initiated) acts as a source device while the second device and any additional devices act as target devices. In some implementations configured to allow a multi-device drag and drop function, client devices may be configured to identify a drag action that leaves the surface of the client device as an “exit event” or “item-leave event,” to identify a drag action that begins from the edge of the client device as an “entrance event” or “item-enter event,” and to report both item-leave events and item-enter events as inter-device connection events.

In the event that an item-leave event is detected at 408, the source device determines that the item-leave event is an inter-device connection event at 410 and reports the item-leave event to the inter-device connectivity management server 103 at 414. In various implementations, the data corresponding to the detected item-leave event reported at 414 may vary. The reported data includes a time stamp, a device ID, and a screen location at which the item-leave event began and a screen location at which the item-leave event exited the screen of the source device. The time stamp may include a time at which the drag event began and a time at which the drag left the screen. The reported data may further include a number of data points representing screen position and time pairs corresponding to a screen position traversed by a swipe or drag gesture and the time at which the swipe or drag gesture traversed the particular screen position. Additional information may also be recorded and transmitted at 414. For example, a time stamp and drag information corresponding to the presence of a second finger or stylus selecting a second object to drag to the edge of the screen in a second drag gesture may also be transmitted at 414 along with the information pertaining to the first drag gesture.

Meanwhile, the recipient device will detect an item-enter event once the drag gesture continues onto the screen of the recipient device. The recipient device will detect the item-enter event at a corresponding 408, determine that an inter-device connection event has been detected at a corresponding 410, and transmit data corresponding to the item-enter event at a corresponding 414. The data corresponding to the item-enter event transmitted to the connectivity management server 103 by the recipient device at 414 may include but is not limited to a time stamp (which may include a time at which the drag event entered the screen and a time at which the drag event terminated), a device ID, a screen location at which the item-enter event entered the screen and a screen location at which the item-enter event terminated, and a set of data points each representing a screen position-time pair and indicating a time at which the swipe or drag gesture traversed the particular screen position. Furthermore, additional information, e.g. data corresponding to a second simultaneous drag gesture, may be transmitted at 414. Nevertheless, each of these detection and transmission steps executed by the recipient device will occur at a slightly later time on the recipient device than on the source device as a result of the time it takes to execute the drag action.

Once both the source device and the recipient device have transmitted the data representative of the item-leave event to the inter-device connectivity management server 103, the connectivity management server determines if the two events match. Determining that the connectivity events match may require that the time-stamps of the enter and exit portions of the swipe or drag gesture are within a threshold amount of time, that the trajectory of the swipe or drag is constant within a threshold over the course of the swipe or drag, and that the velocity of the swipe or drag is constant within a threshold over the course of the swipe or drag. If the server determines that the two events do not match, both clients receive a response from the server indicating that the inter-device connection was not confirmed by the server and the processes executing on each client device proceed to 418. Note that the same occurs if only a single item-leave or item-enter event was transmitted (albeit on only a single device). However, if the server confirms that the item-leave event reported by the source device matched the item enter event reported by the target device, the server will transmit a confirmation to the devices. Thereafter, the source device will transmit the files that were dragged across to the receiving device to the inter-device connectivity management server 103 and the server will transmit the files to the receiving device which will store the files in local memory and may also produce a visual representation of the files, e.g. on a virtual scrapboard.

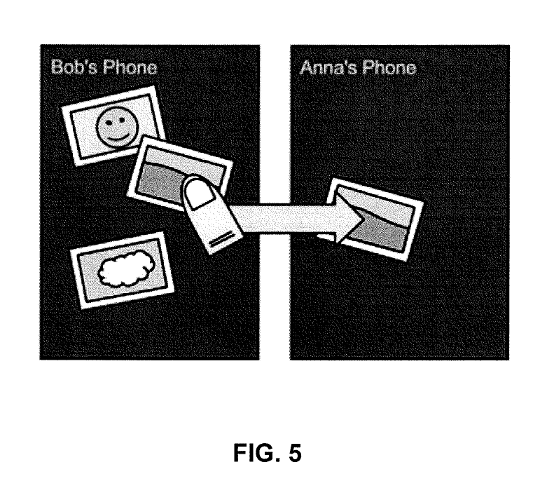

FIG. 5 depicts an inter-device connectivity user interface at two distinct client devices aligned adjacent to one another. Specifically, FIG. 5 depicts a virtual scrapboard interface loaded onto two client devices, Bob's Phone 101A and Anna's Phone 101B. FIG. 5 further depicts the user input required to transfer a file from Bob's Phone 101A to Anna's phone 101B using the drag and drop inter-device connection event described above.

In addition to inter-device drag and drop file sharing, client devices contemplated by the invention may recognize a number of additional inter-device connection events. For example, once a file has been shared within a connectivity cluster, settings may enable a designated user or any user to select the file and thereby cause the file to be simultaneously displayed by all devices participating in the connectivity cluster or share group. For example, a user may double tap on a shared image from within the client-side inter-device connectivity UI and the server may transmit an instruction to all devices within the connectivity cluster to display the file. In the context of FIG. 4, at 408 the client device 101 receives input indicating a request that all devices with which a photo has been shared display the photo. For example, a user may double tap a shared photo from within the inter-device connectivity UI output at 402 to indicate a desire to have the photo displayed on all shared devices. At 410, the client device determines that the input corresponds to an inter-device connection event. At 414 the client device transmits data corresponding to the shared viewing event to the inter-device connectivity management server 103. The data corresponding to the shared viewing event may include a device ID corresponding to the device requesting the shared viewing event, a file ID corresponding to the file that is to be viewed during the shared viewing event, and may further include additional information, e.g. identities of other members of the connectivity cluster that will participate in the shared viewing event. Also at 414, the client device receives feedback from the connectivity server determining whether or not the shared viewing event can be executed. The connectivity server may transmit a shared viewing session failed notification if there are no additional devices with which the photo has been shared or may transmit a shared viewing session confirmed notification if the requirements for a shared viewing session have been met. At 420 the client devices participating in the shared viewing session may output a notification, and at 422 each client device participating in the shared viewing session displays the file selected for the shared viewing event.

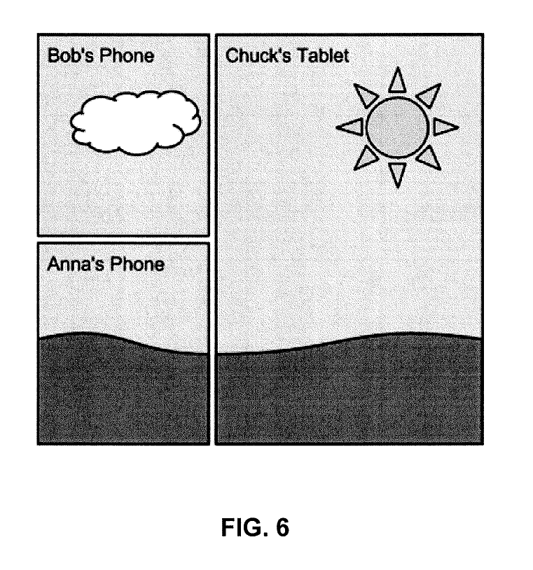

Another inter-device connection event contemplated by the invention is an expanded viewing event. FIG. 6 depicts three client devices arranged next to one another in order to form a mosaic during an expanded viewing event. Each device displays a portion of the image that corresponds to its location relative to the other devices in the physical world. For example, Bob's Phone 101A displays the upper left hand portion of the image, Anna's Phone 101B displays the lower left hand portion of the image, and Chuck's Tablet 101C displays the right portion of the image. The precise proportion of the image depicted by each individual client device is a response to data transmitted by the inter-device connectivity management server 103 to each of the client devices. The inter-device connectivity management server 103 determines the appropriate portion of the image to assign to each client device through analysis of image data and data corresponding to the relative size and orientation of the devices.

In the context of FIG. 4, at 408 one of the client devices receives input indicating a request that the devices be utilized in an expanded viewing event. For example, a user may double tap a photo that has previously been shared with other devices within a connectivity cluster or a share group. At 410, the client device determines that the input corresponds to an inter-device connection event. At 414 the client device transmits data corresponding to the shared viewing event to the inter-device connectivity management server 103. The data corresponding to the shared viewing event may include a device ID corresponding to the device requesting the shared viewing event, a file ID corresponding to the file that is to be viewed during the shared viewing event, and may further include additional information, e.g. identities of other members of the connectivity cluster that will participate in the expanded viewing event. Also at 414, the client device 101 receives feedback from the inter device connectivity server 103 determining whether or not the expended viewing event can be executed. In determining whether or not an expanded viewing event can be executed, the connectivity server determines whether or not the relative positions of the devices involved in the expanded viewing event are known. If the relative positions are unknown, the connectivity server may transmit a failure message to the requesting client device 101. Alternatively, the server may also simply select all devices whose position relative to the requesting client device 101 are known for inclusion in the expanded viewing event and transmit a failure message only if there are no additional devices in the connectivity cluster or share group whose positions are known relative to the requesting client device 101.

The inter-device connectivity server 103 can determine the relative positions of the client devices in a connectivity cluster or share group based upon inter-device swipe or drag gestures. During an inter-device swipe or drag gesture, both the source client device and the recipient client device may transmit data to the server that includes data pertaining to physical dimensions of the devices. Furthermore, the source device may transmit data pertaining to the position and time at which the drag gesture began, the position and time at which the drag gesture left the source device, and position-time pair data points corresponding to intermediate portions of the drag event. Similarly, the recipient device may transmit data pertaining to the position and time at which the drag gesture entered the recipient device, the position and time at which the drag gesture terminated, and position-time pair data points corresponding to intermediate portions of the drag event. The inter-device connectivity server can utilize the data pertaining to the inter-device drag gesture and physical device size to infer the relative positions of the source and recipient device. For example, if the devices have the same height of ten inches, the drag gesture leaves the source device on the right side at six inches and enters the target device on the left at 4 inches, the connectivity server can infer that the target device is on the right, two inches lower than the source device on the left. Relative positions can be calculated even more accurately if the angle and speed of the drag event is accounted for as well. Furthermore, the client devices 101 may be configured to report any signals (or signals that meet particularly criteria, e.g. signals that deliver a threshold level of power) produced by the motion sensors 290 to the connectivity management server 103. The inter-device connectivity management server 103 may utilize data corresponding to the signals generated by the motion sensors 290 to determine slight changes in the devices relative orientation since the drag event or to determine if the relative location of the devices is no longer known with a threshold degree of certainty.

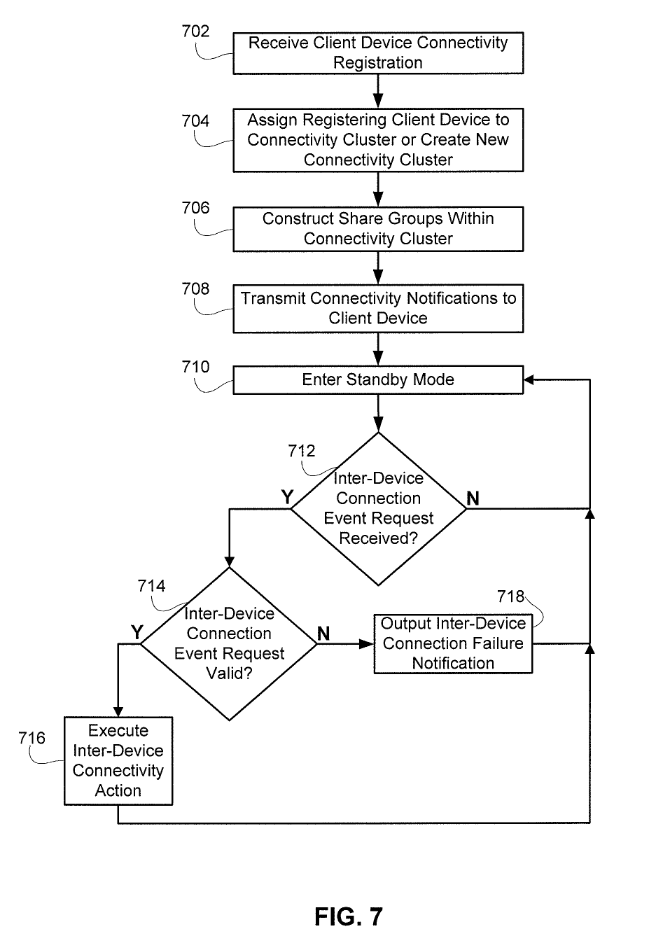

FIG. 7 is a flow diagram illustrating an example process, implemented at an inter-device connectivity management server, for establishing and managing an inter-device connectivity cluster. At 702, the inter-device connectivity management server 103 receives a registration request from the client device 101. The registration request received at 702 may originate from the client device, e.g. as a result of a user instructing the client device 101 to display an inter-device connectivity user interface (UI). Alternatively, the registration request received at 702 may originate from a computerized device that is communicatively coupled to one or more client devices that might be included in a connectivity cluster. For example, the request received at 702 may originate from a WIFI access point, such as a wireless router. The registration request received by the connectivity management server at 702 is accompanied by data representative of the geographic location of the registering client device. In implementations where the functionality provided by the connectivity management server is distributed across multiple physically distinct devices or across multiple processors, registration requests received at 402 may be routed to particular processors or physical devices based upon the geographic location data included in the request. Data representative of the geographic location included in a join request may include but is not limited to GPS coordinates, a received signal strength indication (RSSI) corresponding to a particular wireless access point (WAP), an identifier for an object that serves as a reference point in the real world, accelerometer data capable of determining movement from a known reference point, and any other data capable of representing a physical location in the real world. Registration requests may also be accompanied by a unique device ID that the connectivity server can use to identify the registering client device 101.

At 704, the inter-device connectivity management server 103 assigns the registering client device 101 to a preexisting connectivity cluster or creates a new connectivity cluster if necessary to accommodate the registration of the client device 101. In various implementations, the connectivity management server may utilize various criteria in assigning the registering client to a connectivity cluster. Criteria for determining candidacy may be dependent upon the characteristics of the geographic location at which the registering client is located. For example, a first set of requirements for candidacy may be specified for locations that correspond to public areas where a large number of client devices are likely to be present while a second set of criteria may be specified for locations that correspond to private settings where relatively few client devices are likely to be located. For example, if the location corresponds to a public area characterized by large numbers of mobile devices, the inter-device connectivity management server may further require information pertaining to the user account affiliated with the client device such as an address book, a communication history, or a social network connection list. In crowded areas, the inter-device connectivity server may utilize such additional information in order to provide a higher degree of accuracy to inter-device gestures by refusing to acknowledge inter-device gestures that appear to have been made between devices whose affiliated user accounts do not have a sufficient degree of contact. The server may also require that various additional information corresponding to the client device has been received as a prerequisite for assignment to a connectivity cluster. For example, the server may require that join requests transmitted by potential candidate client devices include a physical size of a display screen, a pixel count of a display screen, physical dimensions of the client device, physical dimensions of a border region surrounding a presence-sensitive display screen of the potential candidate client device, and a variety of additional data pertaining to the potential candidate client device.

In implementations where connectivity clusters have rules dependent upon the characteristics of the location to which they correspond, the process may construct share groups within a connectivity cluster at 706. The share groups may be data structures stored at a computer readable storage medium, e.g. the memory 302, the storage devices 304, or the database 104. The share group data structure may itself include data structures representative of member client devices and additional data structures representative of user accounts affiliated with the client devices. The share group data structure may be a component of a connectivity cluster data structure. Similarly, the share group data structure may simply include references to data structures representative of member client devices and user accounts affiliated with the client devices and may merely be referenced by a connectivity cluster data structure. The share group may further include sets of rules and procedures that govern the interaction between the member client devices. Such rules and procedures may be specified by data located within a connectivity cluster data structure, within a share group data structure, and within data structures corresponding to user accounts or client devices.

In constructing the share group at 706, the connectivity management server 103 may utilize a selection criteria to determine which client devices in the connectivity cluster to consider for membership in the share group. The selection criteria may be dependent upon the information received by the inter-device connectivity management server 103 from the registering client devices, such as an address book, a communication history, or a social network connection list. In various implementations, user account social networks, user account contact lists, and user account communication history may be utilized in the selection criteria for determining membership in a share group. For example, if multiple client devices co-located at a particular geographic location transmit registration requests to the inter-device connectivity management server 103, the server may place some of the client devices in a share group while excluding devices associated with a social network account that does not have a threshold number of connections of a particular degree with the user accounts affiliated with the client devices placed in the share group. Similarly, candidate client devices associated with a user account that has not communicated one or more of the other user accounts associated with the client devices in a share group may not be permitted to join the share group.

At 708, the connectivity management server 103 transmits notifications of the placement into a connectivity cluster (and share group) to the registering client device 101. The server may transmit failure notifications to clients that attempted to register with the connectivity server but could not be assigned to a connectivity cluster.

At 710, the inter-device connectivity management server enters a standby mode in which the server waits to receive a request or other data transmission from one or more of the client devices in the connectivity cluster or share group. At 712, the inter-device connectivity management server 103 determines whether an inter-device connection event request was received during the current standby cycle. A standby cycle may be a defined period of time during which the server waits to receive an indicia of an inter-device connection event. If no inter-device connection event request is received during the standby cycle, the process returns to 710 where a new standby cycle begins. However, if an inter-device connection request was received, the process proceeds to 714.

At 714, the inter-device connectivity management server 103 determines whether or not the inter-device connection event request is valid. The connectivity management server may utilize various criteria to determine whether or not different types of requested connection events are valid. For example, an exit event or item-leave event corresponding to an inter-device drag gesture may require a corresponding and matching entrance event or item-enter event reported by another client device in the connectivity cluster or share group. By contrast, an expanded viewing event request may only require that the connectivity management server be able to ascertain the location of one or more client devices relative to the requesting client device. If the validity criteria corresponding to the type of inter-device connectivity event request received at 712 is not met, the server determines that the inter-device connectivity event request is invalid and the process proceeds to 718 where a inter-device connection failure notification is transmitted to one or more client devices. By contrast, if the validity criteria corresponding to the type of inter-device connectivity event request received at 712 is met, the server determines that the inter-device connectivity event request is valid and the process proceeds to 716 where the requested inter-device connectivity action is executed by the inter-device connectivity management server 103.

Determining whether the inter-device connection event request is valid varies based upon the type of inter-device connection request received at 712. In the case of an inter-device drag gesture, validity may require the satisfaction of a variety of conditions. Note that in various implementations certain validity requirements mentioned herein may be foregone. Similarly, the invention entails implementations where validity requirements not mentioned herein are utilized. Validity requirements for an inter-device drag and drop operation wherein a user is able to transfer data, files, multimedia, etc. from a source device to a target device by dragging an item from a touch sensitive display of a first client device to a touch sensitive display of a second client device may differ from those required for a drag-to-connect gesture where no files are transferred between client devices. In general, validity of inter-device drag events requires that the inter-device connectivity management server receive data pertaining to an entrance event reported by a first client device that matches data pertaining to an exit event reported by a different client device.

When a user begins a drag gesture on one screen and completes it on another, the drag action exits a touch sensitive screen of the first device, the source device, and enters a touch sensitive screen of a second device, the recipient device. When the drag action exits the touch sensitive screen of the source device, the source device determines that an exit event has occurred and transmits data corresponding to the exit event to the inter-device connectivity management server 103. The exit event data can include a variety of data pertaining to the drag gesture performed by the user not limited to a timestamp (i.e. the time at which the gesture was performed), a location at the touch sensitive screen of the first client device, and a trajectory or direction of the drag gesture. When the drag action continues on the touch sensitive screen of the recipient device, the recipient device determines that an entrance event has occurred and transmits the entrance event as a request to perform a data resource sharing operation. The entrance event can include a variety of information pertaining to the drag gesture performed by the user not limited to a timestamp (i.e. the time at which the gesture was performed), a location at the touch sensitive screen of the second client device, and a trajectory or direction of the drag gesture.

Determining whether the entrance event matches the exit event can involve comparing the data from the exit event with the entrance event in order to determine whether or not the two events match. In various implementations various criteria may be utilized to determine whether an exit event matches an entrance event. For example, the connectivity server may determine that a match exists only if the timestamps of the exit and entrance events are within a threshold proximity of each other and the trajectory of the exit event matches that of the entrance event. Determining whether the trajectory of the exit event matches that of the entrance event may utilize different criteria in different implementations. For example, the entrance event must begin at an edge of the touch sensitive screen of the recipient device that is opposite the edge of the touch sensitive screen of the source device from which the exit event occurred. The existence of a match may be predicated upon the angle and speed of the exit dragging event corresponding to the angle and speed of the entrance dragging event. Match detection may also require that physical touch data developed during the exit event at the source device match that developed during the entrance event at the recipient device.

In the case of an expanded viewing event request (in which a single viewable file is output on a display composed of two or more component displays, each component display being a display of a client device), validity requires a different set of criteria be met. Note that in various implementations certain validity requirements mentioned herein may be foregone. Similarly, the invention entails implementations where validity requirements not mentioned herein are utilized. In general, the validity of an expanded viewing event requires that the relative locations of at least two client devices be known. If the location of at least two client devices relative to one another is not known with a sufficient degree of particularity, any request for an expanded viewing event may be deemed invalid. It is noteworthy that the relative location must be current. For example, if the relative locations of two devices is known at one point in time but motion sensor data provided by the two devices suggests their relative location is no longer accurately known, the inter-device connectivity server will be unable to utilize their relative physical location in performing an expanded viewing event.

The inter-device connectivity server 103 can determine the relative positions of the client devices in a connectivity cluster or share group based upon inter-device swipe or drag gestures. During an inter-device swipe or drag gesture, both the source client device and the recipient client device may transmit data to the server that includes data pertaining to physical dimensions of the devices. Furthermore, the source device may transmit data pertaining to the position and time at which the drag gesture began, the position and time at which the drag gesture left the source device, and position-time pair data points corresponding to intermediate portions of the drag event. Similarly, the recipient device may transmit data pertaining to the position and time at which the drag gesture entered the recipient device, the position and time at which the drag gesture terminated, and position-time pair data points corresponding to intermediate portions of the drag event. The inter-device connectivity server can utilize the data pertaining to the inter-device drag gesture and physical device size to infer the relative positions of the source and recipient device. Relative positions can be calculated even more accurately if the angle and speed of the drag event is accounted for as well. Furthermore, the client devices 101 may be configured to report any signals (or signals that meet particularly criteria, e.g. signals that deliver a threshold level of power) produced by the motion sensors 290 to the connectivity management server 103. The inter-device connectivity management server 103 may utilize data corresponding to the signals generated by the motion sensors 290 to determine slight changes in the devices relative orientation since the drag event or to determine if the relative location of the devices is no longer known with a threshold degree of certainty.

Similarly, executing the inter-device connectivity action at 716 varies depending upon the type of inter-device connection event request received at 712. Executing an inter-device drag and drop gesture may merely involve transmitting data representative of a file received from the source device to the recipient device. Executing an expanded viewing event may be considerably more complex. Executing an expanded viewing event requires assigning a portion of a viewable file to each device participating in the expanded viewing event and coordinating the simultaneous display of each portion on each respective device.

It is contemplated that other implementations may differ in detail from the foregoing examples. As such, all references are intended to reference the particular implementation being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to retrieve content from a content server. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as, for example, to a city, ZIP code, or state level), so that a particular location of a user cannot be determined. Thus, the user may have control over how information is collected about him or her and used by the systems discussed herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Variations of the embodiments disclosed herein may become apparent to those of ordinary skill in the art upon reading the foregoing description. Skilled artisans may employ such variations as appropriate, and the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system comprising:
a first client device;
a second client device; and
a server;
wherein the first client device is configured to:
detect an exit gesture; and
transmit exit gesture data generated by the exit gesture;
wherein the second client device is configured to:
detect an entrance gesture; and
transmit entrance gesture data generated by the entrance gesture;
wherein the server is configured to:
receive the exit gesture data;
receive the entrance gesture data;
determine a gesture type of an inter-device gesture, formed from the exit gesture data and the entrance gesture data;
transmit a pairing message;
manage inter-device connectivity between the first client device and the second client device within a first inter-device connectivity cluster;
determine an existence of a condition, the condition being that a candidate client device has a received signal strength that exceeds a threshold signal strength and that a signal from the candidate client device indicates an intent of the candidate client device to share data with another candidate client device; and
establish, in response to the existence of the condition, a second inter-device connectivity cluster that includes the candidate client device.

2. The system of claim 1, wherein:
the second client device is further configured to receive a portion of the exit gesture data; and
the server is further configured to transmit the portion of the exit gesture data to the second client device.

3. The system of claim 1, wherein:
the first client device is further configured to:
receive a first response from the server; and
execute a first action in response to receiving the first response from the server; and
the second client device is configured to:
receive a second response from the server, and
execute a second action in response to receiving the second response from the server; and
the server is further configured to transmit a message containing an identifier for the gesture type to the first client device and the second client device.

4. The system of claim 1, wherein:
the first client device comprises a first touch sensitive screen and is further configured to transmit a first device identifier uniquely identifying the first client device, a physical size of the first touch sensitive screen, and location data corresponding to a present location of the first client device; and
the second client device comprises a second touch sensitive screen and is further configured to transmit a second device identifier uniquely identifying the second client device, a physical size of the second touch sensitive screen, and location data corresponding to a present location of the second client device.

5. The system of claim 4, wherein:
the exit gesture data comprises:
a time and position pair data point corresponding to a point at which the exit gesture began; and
a time and position pair data point corresponding to a point at which the exit gesture ended; and
the entrance data comprises:
a time and position pair data point corresponding to a point at which the entrance gesture began; and
a time and position pair data point corresponding to a point at which the entrance gesture terminated.

6. The system of claim 5, wherein:
the exit gesture data further comprises one or more additional time and position pair data points corresponding to intermediate points of the exit gesture; and
the entrance gesture data further comprises one or more additional time and position pair data points corresponding to intermediate points of the entrance gesture.

7. The system of claim 5, wherein:
the inter-device gesture is selected from one of the group consisting of: an inter-device drag and drop gesture and an inter-device drag gesture; and
the determining the gesture type of the inter-device gesture formed from the exit gesture data and the entrance gesture data comprises:
determining that the inter-device gesture formed from the exit gesture data and the entrance gesture data is a successful inter-device drag gesture if two conditions are true: a time at which the exit gesture terminated is within a threshold range of a time at which the entrance gesture began, and the present location of the first client device is within a threshold range from the present location of the second client device; and
determining that the inter-device gesture formed from the exit gesture data and the entrance gesture data is an unsuccessful inter-device drag gesture if any of the two conditions is not true.

8. The system of claim 5, wherein:
the inter-device gesture is selected from one of the group consisting of: an inter-device drag and drop gesture and an inter-device drag gesture; and
the determining the gesture type of the inter-device gesture formed from the exit gesture data and the entrance gesture data comprises:
determining a velocity of the exit gesture from the time and position pair data points corresponding to the point at which the exit gesture began and the time and position pair data points corresponding to the point at which the exit gesture ended;
determining a trajectory of the exit gesture from the time and position pair data points corresponding to the point at which the exit gesture began and the time and position pair data points corresponding to the point at which the exit gesture ended;
determining a velocity of the entrance gesture from the time and position pair data points corresponding to the point at which the entrance gesture began and the time and position pair data points corresponding to the point at which the entrance gesture ended;
determining a trajectory of the entrance gesture from the time and position pair data points corresponding to the point at which the entrance gesture began and to the point at which the entrance gesture terminated;
determining that the inter-device gesture formed from the exit gesture data and the entrance gesture data is a successful inter-device drag gesture if four conditions are true: the velocity of the exit gesture is within a threshold range of the velocity of the entrance gesture, the trajectory of the exit gesture is within a threshold range of the trajectory of the entrance gesture, the time at which the exit gesture ended is within a threshold range of the time at which the entrance gesture began, and the present location of the first client device is within a threshold range from the present location of the second client device; and
determining that the inter-device gesture formed from the exit gesture data and the entrance gesture data is an unsuccessful inter-device drag gesture if any of the four conditions is not true.

9. The system of claim 2, wherein:
the exit gesture data further comprises data that composes a file stored at the first client device; and
the portion of the exit gesture data is the data that composes the file stored at the first client device.

10. The system of claim 3, wherein:
the first action comprises transmitting data composing a target file; and
the second action comprises receiving the data composing the target file.

11. The system of claim 10, wherein:
the target file is configured to be displayed visually;
the first client device is further configured to:
receive a signal that triggers an expanded view,
transmit a request for an expanded viewing event, and
receive a first instruction from the server;
the second client device is further configured to receive a second instruction from the server; and
the server is further configured to:
receive the request for the expanded viewing event,
determine a relative position of the first client device and the second client device,
assign a first portion of the target file to the first client device,
assign a second portion of the target file to the second client device,
transmit the first instruction to the first client device to display the first portion of the target file, and
transmit the second instruction to the second client device to display the second portion of the target file.

12. The system of claim 11, wherein the determining the relative position of the first client device and the second client device comprises comparing the exit gesture data, the entrance gesture data, data representing a physical size of a first touch sensitive screen of the first client device, and data representing a physical size of a second touch sensitive screen of the second client device.

13. A client device comprising one or more processors and computer readable storage media, the client device further comprising:
a touch sensitive screen configured to detect a drag gesture and to produce a signal corresponding to the drag gesture; and
an inter-device connection engine configured to determine if the drag gesture is an exit event, and to transmit data representative of the drag gesture, if the drag gesture is the exit event, to an inter-device connectivity management server,
wherein the inter-device connectivity management server is configured to:
manage an inter-device connectivity between the client device and the second client device within a first inter-device connectivity cluster;
determine an existence of a condition, the condition being that a candidate client device has a received signal strength that exceeds a threshold signal strength and that a signal from the candidate client device indicates an intent of the candidate client device to share data with another candidate client device; and
establish, in response to the existence of the condition, a second inter-device connectivity cluster that includes the candidate client device.

14. The client device according to claim 13, wherein the data representative of the drag gesture comprises one or more of the group consisting of: a time and position pair corresponding to a start of the drag gesture that is the exit event and a time and position pair corresponding to an end of the drag gesture that is the exit event.

15. The client device according to claim 13, wherein the inter-device connection engine is further configured to determine if the drag gesture is an entrance event, and to transmit the data representative of the drag gesture if the drag gesture is the entrance event.

16. The client device according to claim 15, wherein the data representative of the drag gesture comprises one or more of the group consisting of: a time and position pair corresponding to a start of the drag gesture that is the entrance event and a time and position pair corresponding to an end of the drag gesture that is the entrance event.

17. The client device according to claim 13, wherein the inter-device connection engine is further configured to transmit data that composes a viewable file.

18. The client device according to claim 17, wherein the inter-device connection engine is further configured to transmit an expanded viewing request and to receive an instruction to display a portion of the viewable file, wherein the portion is determined based upon a position of the client device relative to a position of another client device.

19. The client device according to claim 17, wherein the inter-device connection engine is further configured to transmit a shared viewing event request, wherein the shared viewing event request directs a server to send instructions to one or more additional client devices to display the viewable file.

20. A method performed by an inter-device connectivity management server for recognizing an inter-device gesture originated at a first client device and consummated at a second client device, the method comprising:
receiving, from the first client device, first data corresponding to a first drag event detected at the first client device;
receiving, from the first client device, data composing a file;
receiving, from the second client device, second data corresponding to a second drag event detected at the second client device;
determining whether the first data matches the second data; and
transmitting the file received from the first client device to the second client device when the first data matches the second data;
wherein the first data comprises a time at which the first drag event ended and a location of the first client device;
wherein the second data comprises a time at which the second drag event began and a location of the second client device;
wherein the determining whether the first data matches the second data comprises determining whether the time at which the first drag event ended is within a threshold of the time at which the second drag event began and determining whether the location of the first device is within a threshold distance of the location of the second device; and
wherein the inter-device connectivity management server is configured to:
manage an inter-device connectivity between the first client device and the second client device within a first inter-device connectivity cluster;
determine an existence of a condition, the condition being that a candidate client device has a received signal strength that exceeds a threshold signal strength and that a signal from the candidate client device indicates an intent of the candidate client device to share data with another candidate client device; and
establish, in response to the existence of the condition, a second inter-device connectivity cluster that includes the candidate client device.

21. The system of claim 24, wherein the network access point comprises a WiFi access point, wherein the received signal strength comprises a received signal strength indication (RSSI) received by the candidate client device from the WiFi access point, and wherein the threshold signal strength comprises a threshold RSSI.

22. The client device according to claim 25, wherein the network access point comprises a WiFi access point, wherein the received signal strength comprises a received signal strength indication (RSSI) received by the candidate client device from the WiFi access point, and wherein the threshold signal strength comprises a threshold RSSI.

23. The method of claim 26, wherein the network access point comprises a WiFi access point, wherein the candidate client device is permitted to transfer gesture data within the received signal strength comprises a received signal strength indication (RSSI) from the WiFi access point, and wherein the threshold signal strength comprises a threshold RSSI.

24. The system of claim 1, wherein the is received by the candidate client device from a network access point.

25. The client device according to claim 13, wherein the received signal strength is received by the candidate client device from a network access point.

26. The method of claim 20, wherein the received signal strength is received by the candidate client device from a network access point.
